(19) United States
(12) Patent Application Publication
(10) Pub. No.: US 2026/0086916 A1
(43) Pub. Date: Mar. 26, 2026

(54) SOFTWARE VERIFICATION SYSTEM, AND VEHICLE CONTROL DEVICE

(71) Applicant: HITACHI ASTEMO, LTD., Ibaraki (JP)

(72) Inventors: Hiroki OMATSU, Tokyo (JP); Satoshi OTSUKA, Tokyo (JP); Kentaro YOSHIMURA, Tokyo (JP); Masashi MIZOGUCHI, Tokyo (JP); Koji MAEDA, Hitachinaka (JP); Masakazu IKEDA, Hitachinaka (JP); Hiroaki ITO, Hitachinaka (JP)

(21) Appl. No.: 19/112,340

(22) PCT Filed: Sep. 19, 2023
(86) PCT No.: PCT/JP2023/033912

§ 371 Date: Mar. 17, 2025

(30) Foreign Application Priority Data
Sep. 29, 2022 (JP) 2022-156524

(51) Int. Cl. G06F 11/3604

(52) U.S. Cl. CPC G06F 11/3608

(57) ABSTRACT

A software verification system and the like that can facilitate improvement of software using sensor data of a vehicle as an input are provided. The software verification system detects (performance determining unit 118) a degradation of a new version of control software using, first information that is an output of a current version of control software used for control of a vehicle using, as an input, sensor data from a sensor mounted on the vehicle, second information that is an output of the new version of control software not used for the control of the vehicle using, as an input, the sensor data, and third information relating to the control of the vehicle other than the first and second information; and verifies the new version of control software by using the sensor data when the degradation is detected.

### TECHNICAL FIELD

The present invention relates to a software verification system and a vehicle control device.

### Background Art

In NPL 1, various methods are introduced as a software safety evaluation method, and in particular, in the evaluation method by Shadow Mode, highly accurate evaluation can be expected while ensuring safety since the software is executed in the background and evaluated by using the external environment information in a real vehicle.

PTL 1 proposes a technique of executing old version software and new version software side by side or in parallel and outputting inconsistency information at the time of comparing output results. Not only are data sensed in the real environment by the real vehicle used as input information, but simultaneous verification can be performed by a plurality of vehicles, which is effective from the viewpoint of verification system and efficiency.

### CITATION LIST

### Non-Patent Literature

NPL 1: S Riedmaier et al., “Survey on Scenario-Based Safety Assessment of Automated Vehicles,” in IEEE Access, 2020.

### Patent Literature

PTL 1: JP 2022-13187 A

### SUMMARY OF INVENTION

### Technical Problem

In the Shadow Mode technique of NPL 1, new target software is executed and verified in the real vehicle in the background separately from the old software. As a result, a result of executing the target software in the background using real vehicle acquired data can be acquired. However, there is a problem that enormous time is required to evaluate all the execution results. Therefore, a method of evaluating execution results of the old software and the new software is desired.

In PTL 1, two versions of software, new and old, are executed side by side (operation on one CPU) or in parallel (operation on a plurality of CPUs) by using (verification scenario) acquired while the vehicle is traveling. Accordingly, software verification can be exclusively performed. However, it is difficult for the system to perform performance determination (improve or degrade) of the new software on the vehicle with respect to a difference between the execution results of the old software and the new software, and an enormous work man-hours are required for a human to perform the performance determination. In addition, in a case where the same output is performed in both the old software and the new software, and an erroneous output result is obtained, it is difficult to perform evaluation because a difference between the execution results cannot be obtained. Therefore, it is a problem to perform performance determination on the difference between the execution results of the old software and the new software in the system on the vehicle, and to also perform determination in a case where inappropriate outputs are obtained for both the old software and the new software.

An object of the present invention is to provide a software verification system and the like that can facilitate improvement of software using sensor data of a vehicle as an input.

### Solution to Problem

In order to achieve the above object, a software verification system according to an example of the present invention detects a degradation of a new version of control software using first information that is an output of a current version of control software used for control of a vehicle using, as an input, sensor data from a sensor mounted on the vehicle, second information that is an output of the new version of control software not used for the control of the vehicle using, as an input, the sensor data, and third information relating to the control of the vehicle other than the first and second information, and verifies the new version of control software by using the sensor data when the degradation is detected.

### Advantageous Effects of Invention

According to the present invention, it is possible to facilitate improvement of software using sensor data of a vehicle as an input. Problems, configurations, and effects other than those described above will be clarified by the description of the following embodiments.

### BRIEF DESCRIPTION OF DRAWINGS

FIG. 1 is a diagram illustrating an overall configuration of a vehicle control device according to a first example of the present invention.

FIG. 2 is a diagram illustrating an example of a connection relationship between the vehicle control device and a control device connected via a network according to the first example of the present invention.

FIG. 3 is a flowchart illustrating an example of a processing procedure of a radar sensor information acquisition unit according to the first example of the present invention.

FIG. 4 is a diagram illustrating an example of radar sensor information according to the first example of the present invention.

FIG. 5 is a flowchart illustrating an example of a processing procedure of a camera sensor information acquisition unit according to the first example of the present invention.

FIG. 6 is a diagram illustrating an example of camera sensor information according to the first example of the present invention.

FIG. 7 is a flowchart illustrating an example of a processing procedure of an object detection unit using a radar sensor according to the first example of the present invention.

FIG. 8 is a diagram illustrating an example of an object detection result by the radar sensor according to the first example of the present invention.

FIG. 9 is a diagram illustrating an example of an accident avoidance necessity flag based on an object detection result by the radar sensor according to the first example of the present invention.

FIG. 10 is a flowchart illustrating an example of a processing procedure of an object detection unit by Ver. N software using a camera sensor according to the first example of the present invention.

FIG. 11 is a diagram illustrating an example of an object detection result by Ver. N software using the camera sensor according to the first example of the present invention.

FIG. 12 is a diagram illustrating an example of an accident avoidance necessity flag based on the object detection result by Ver. N software using the camera sensor according to the first example of the present invention.

FIG. 13 is a flowchart illustrating an example of a processing procedure of an object detection unit by Ver. N+1 software using the camera sensor according to the first example of the present invention.

FIG. 14 is a diagram illustrating an example of an object detection result by Ver. N+1 software using the camera sensor according to the first example of the present invention.

FIG. 15 is a diagram illustrating an example of an accident avoidance necessity flag based on the object detection result by Ver. N+1 software using the camera sensor according to the first example of the present invention.

FIG. 16 is a flowchart illustrating an example of a processing procedure for server transmitting each software execution result according to the first example of the present invention.

FIG. 17 is a diagram illustrating a system configuration of a server according to the first example of the present invention.

FIG. 18 is a flowchart illustrating an example of a processing procedure of a server reception unit according to the first example of the present invention.

FIG. 19 is a diagram illustrating an example of an accident avoidance necessity determination result held in a server according to the first example of the present invention.

FIG. 20 is a diagram illustrating an example of camera sensor information in a server according to the first example of the present invention.

FIG. 21 is a flowchart illustrating an example of a processing procedure of a performance determining unit configured to perform performance determination of Ver. N+1 software in the server according to the first example of the present invention.

FIG. 22 is a diagram illustrating an example of determined performance of Ver. N+1 software determined in the server according to the first example of the present invention.

FIG. 23 is a flowchart illustrating an example of a processing procedure of a log output unit configured to create and output a log based on determined performance of Ver. N+1 software in the server according to the first example of the present invention.

FIG. 24 is a diagram illustrating an example of log information created based on the determined performance of Ver. N+1 software in the server according to the first example of the present invention.

FIG. 25 is a diagram illustrating an overall configuration of a vehicle control device according to a second example of the present invention.

FIG. 26 is a flowchart illustrating an example of a processing procedure of a performance determining unit of a Ver. N+1 software according to the second example of the present invention.

FIG. 27 is a diagram illustrating an example of determined performance of Ver. N+1 software according to the second example of the present invention.

FIG. 28 is a flowchart illustrating an example of a processing procedure of a log output unit 124 configured to create and output a log based on determined performance of Ver. N+1 software according to the second example of the present invention.

FIG. 29 is a diagram illustrating an example of log information created based on the determined performance of Ver. N+1 software according to the second example of the present invention.

FIG. 30A is a diagram illustrating an overall configuration of a vehicle control device according to a third example of the present invention.

FIG. 30B is a diagram illustrating an overall configuration of a vehicle control device according to a modified example of the third example of the present invention.

FIG. 31 is a flowchart illustrating an example of a processing procedure of a real-time transmission unit configured to transmit log information in real time according to the third example of the present invention.

FIG. 32 is a diagram illustrating an example of real-time transmission log information according to the third example of the present invention.

FIG. 33 is a flowchart illustrating an example of a processing procedure of a non-real-time transmission unit configured to transmit log information in non-real time according to the third example of the present invention.

FIG. 34 is a diagram illustrating an example of non-real-time transmission log information according to the third example of the present invention.

FIG. 35 is a diagram illustrating an overall configuration of a vehicle control device according to a fourth example of the present invention.

FIG. 36 is a flowchart illustrating an example of a processing procedure of a driver input acquisition unit according to the fourth example of the present invention.

FIG. 37 is a diagram illustrating an example of driver input information according to the fourth example of the present invention.

FIG. 38 is a flowchart illustrating an example of a processing procedure of an accident avoidance operation detection unit according to the fourth example of the present invention.

FIG. 39 is a diagram illustrating an example of an accident avoidance operation detection result according to the fourth example of the present invention.

FIG. 40 is a diagram illustrating an example of an accident avoidance operation flag (driver) according to the fourth example of the present invention.

### DESCRIPTION OF EMBODIMENTS

Each of the following examples relate to a software verification system and a vehicle control device (electronic control device) used in the software verification system. Each example has been made to solve a problem of performing performance determination (degradation detection etc.) of new software, and an object thereof is to provide a vehicle control device or the like that enables the performance determination of the new software by a software verification system using the execution results of the old software and the new software, as well as other information.

### First Example

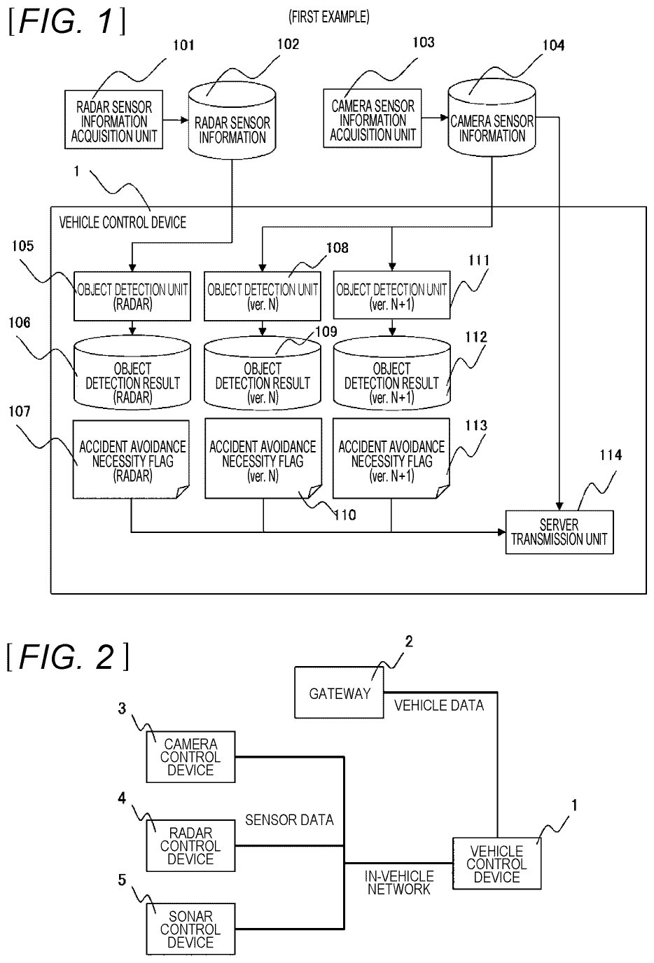

A vehicle control system according to a first example of the present invention will be described with reference to FIGS. 1 through 24.

FIG. 1 is a diagram illustrating an overall configuration of a vehicle control system according to a first example of the present invention.

The vehicle control device 1 includes a radar sensor information acquisition unit 101, radar sensor information 102, a camera sensor information acquisition unit 103, camera sensor information 104, an object detection unit (radar) 105, an object detection result (radar) 106, an accident avoidance necessity flag (radar) 107, an object detection unit (Ver. N) 108, an object detection result (Ver. N) 109, an accident avoidance necessity flag (Ver. N) 110, an object detection unit (Ver. N+1) 111, an object detection result (Ver. N+1) 112, an accident avoidance necessity flag (Ver. N+1) 113, and a server transmission unit 114.

Note that the vehicle control device 1 includes, for example, a processor such as a central processing unit (CPU), a storage device such as a memory, a communication device complying with various communication standards, and the like. Functions of the object detection unit (Ver. N) 108, the object detection unit (Ver. N+1) 111, and the like are realized, for example, by the processor executing software stored in the storage device. Hereinafter, the same applies to other functions.

FIG. 2 is a diagram illustrating an example of a connection relationship between the vehicle control device 1 and a control device connected via a network according to the first example of the present invention. The vehicle control device 1 is connected to a gateway 2, a camera control device 3, a radar control device 4, and a sonar control device 5 by an in-vehicle network. Vehicle data such as a vehicle speed is transmitted from the gateway 2 to the vehicle control device 1. In addition, sensor data derived from a camera sensor, sensor data derived from a radar sensor, and sensor data derived from a sonar sensor are transmitted from the camera control device 3, the radar control device 4, and the sonar control device 5, respectively, to the vehicle control device 1. The vehicle control device 1 performs determination such as advancing, turning, and stopping of the vehicle based on the vehicle data and the sensor data, and realizes control of the vehicle. As illustrated in the drawing, in a vehicle, a plurality of control devices and the gateway are connected by a network, and control of the vehicle is realized by communicating the sensor data, the vehicle data, and the like with each other among the control devices. These network communications are performed periodically or aperiodically.

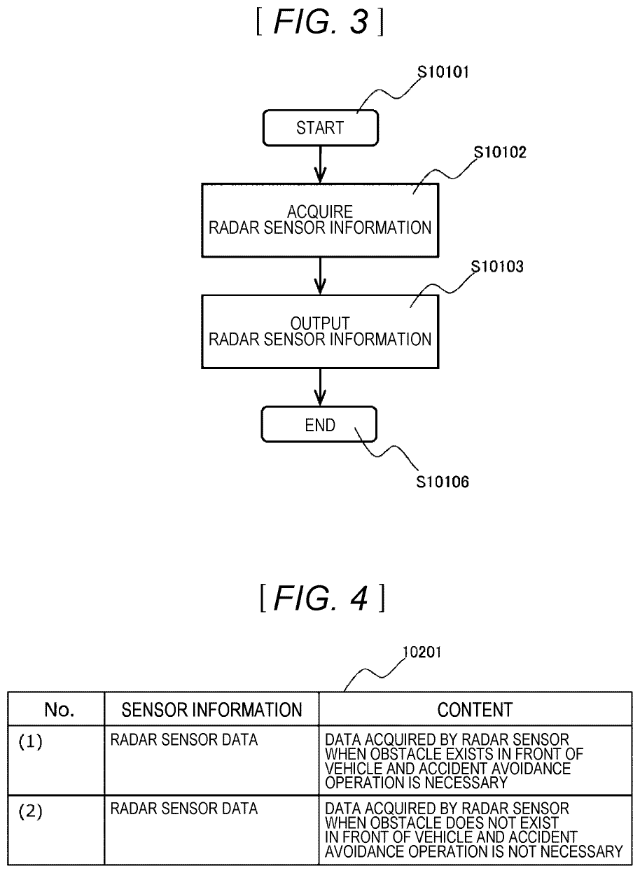

FIG. 3 is a flowchart illustrating an example of a processing procedure of the radar sensor information acquisition unit 101 according to the first example of the present invention. Sensor information at the time of traveling on a road is acquired using a radar sensor. For example, the radar sensor information acquisition unit 101 (radar device) acquires an external field environment in front of the vehicle as sensor information in step S10102 in the drawing, and outputs the sensor information in step S10103. Note that the present invention is not limited to the radar sensor, and other sensors such as a lidar sensor can be substituted (allowed as a modified example).

FIG. 4 is a diagram illustrating an example of radar sensor information 10201 according to the first example of the present invention. Sensor information by the radar includes sensor data (No. (1)) in a case where an obstacle such as a pedestrian exists in front of the vehicle and an accident avoidance operation is necessary, and sensor data (No. (2)) in a case where an obstacle such as a pedestrian does not exist in front of the vehicle and the accident avoidance operation is not necessary. Note that the sensor information includes time stamp information.

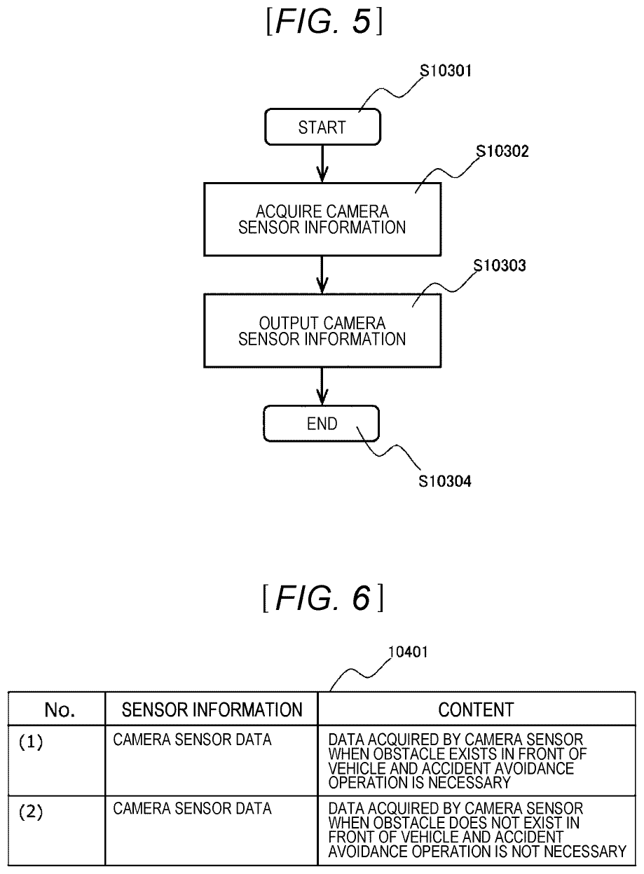

FIG. 5 is a flowchart illustrating an example of a processing procedure of the camera sensor information acquisition unit 103 according to the first example of the present invention. Sensor information at the time of traveling on a road is acquired using a camera sensor. For example, the camera sensor information acquisition unit 103 (camera device) acquires the external field environment in front of the vehicle as sensor information in step S10302 in the drawing, and outputs the sensor information in step S10303.

FIG. 6 is a diagram illustrating an example of camera sensor information 10401 according to the first example of the present invention. Sensor information by the camera includes sensor data (No. (1)) in a case where an obstacle such as a pedestrian exists in front of the vehicle and the accident avoidance operation is necessary, and sensor data (No. (2)) in a case where an obstacle such as a pedestrian does not exist in front of the vehicle and the accident avoidance operation is not necessary. Note that the sensor information includes time stamp information.

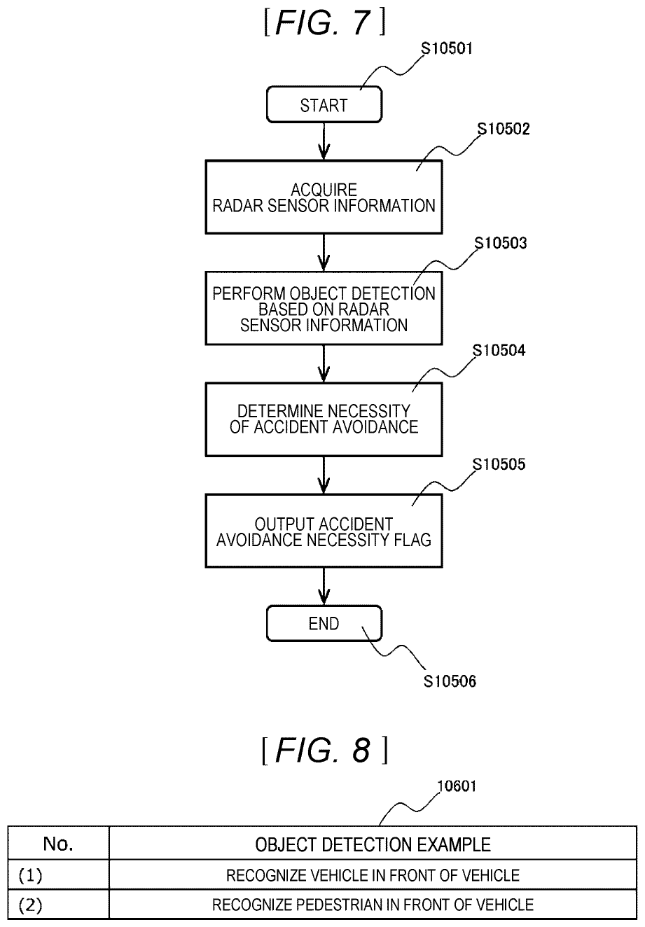

FIG. 7 is a flowchart illustrating an example of a processing procedure of the object detection unit (radar) 105 according to the first example of the present invention. An accident avoidance determination is performed from the acquired radar sensor information. For example, the object detection unit (radar) 105 (processor) acquires the radar sensor information 102 output by the radar sensor information acquisition unit 101 in step S10502 in the drawing, performs an object detection based on the radar sensor information in step S10503, determines necessity of accident avoidance based on an object detection result in step S10504, and outputs an accident avoidance necessity flag in step S10505.

FIG. 8 is a diagram illustrating an example of an object detection result (radar) 10601 according to the first example of the present invention. For example, there are a case where a vehicle in front of the vehicle is recognized (No. (1)) and a case where a pedestrian in front of the vehicle is recognized (No. (2)). Note that the present invention does not limit the detection target.

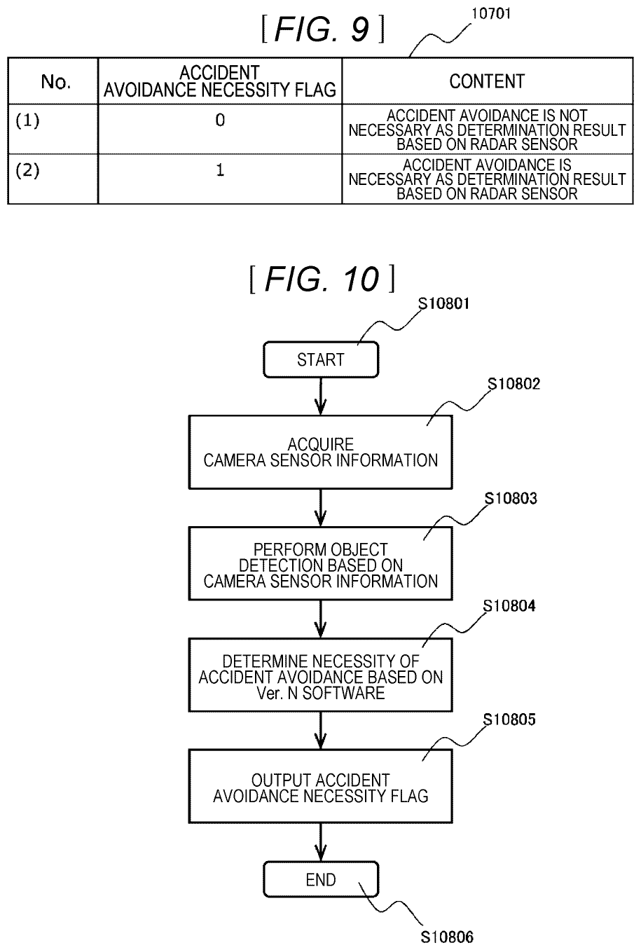

FIG. 9 is a diagram illustrating an example of an accident avoidance necessity flag (radar) 10701 according to the first example of the present invention. An accident occurrence prediction of the vehicle is performed based on the object detection result (radar) 10601, and an accident avoidance necessity flag is determined. For example, there are a flag 0 (No. (1)) in a case where an obstacle (a pedestrian etc.) is not recognized in front and accident avoidance (collision avoidance) is not necessary at the time of traveling of the vehicle, and a flag 1 (No. (2)) in a case where an obstacle is recognized in front and accident avoidance (collision avoidance) is necessary at the time of traveling of the vehicle. Note that the present invention also includes a case where an obstacle is recognized in front of the vehicle but accident avoidance is not necessary. Note that the accident avoidance necessity flag includes time stamp information.

FIG. 10 is a flowchart illustrating an example of a processing procedure of the object detection unit (Ver. N) 108 according to the first example of the present invention. The accident avoidance determination is performed from the acquired camera sensor information. For example, the object detection unit (Ver. N) 108 (processor) acquires the camera sensor information 104 output by the camera sensor information acquisition unit 103 in step S10802 in the drawing, performs the object detection based on the camera sensor information in step S10803, determines the necessity of accident avoidance based on the object detection result in step S10804, and outputs the accident avoidance necessity flag in step S10805.

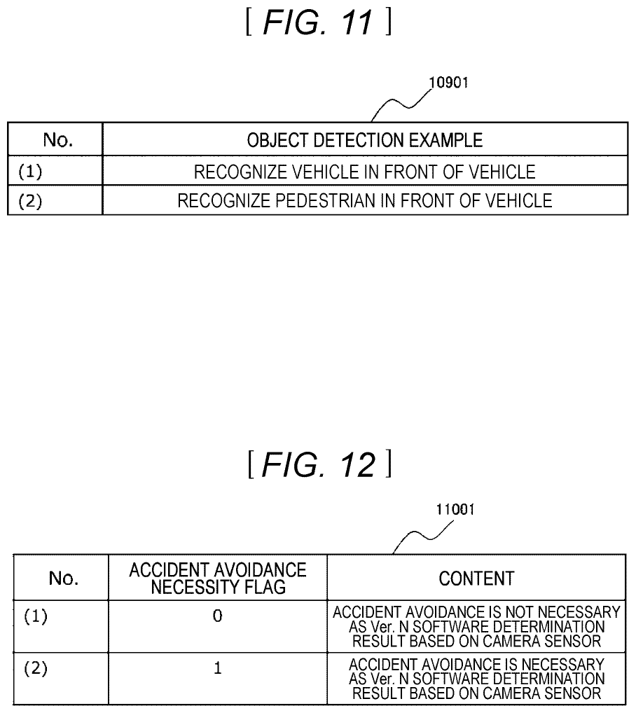

FIG. 11 is a diagram illustrating an example of the object detection result (Ver. N) 10901 according to the first example of the present invention. For example, there are a case where a vehicle in front of the vehicle is recognized (No. (1)) and a case where a pedestrian in front of the vehicle is recognized (No. (2)). Note that the present invention does not limit the detection target.

FIG. 12 is a diagram illustrating an example of an accident avoidance necessity flag (Ver. N) 11001 according to the first example of the present invention. An accident occurrence prediction of the vehicle is performed based on the object detection result (Ver. N) 10901, and an accident avoidance necessity flag is determined. For example, there are a flag 0 (No. (1)) in a case where an obstacle (a pedestrian etc.) is not recognized in front of the vehicle at the time of traveling of the vehicle and accident avoidance is not necessary, and a flag 1 (No. (2)) in a case where an obstacle is recognized in front of the vehicle at the time of traveling of the vehicle and accident avoidance is necessary. Note that the present invention also includes a case where an obstacle is recognized in front of the vehicle but accident avoidance is not necessary. Note that the accident avoidance necessity flag includes time stamp information.

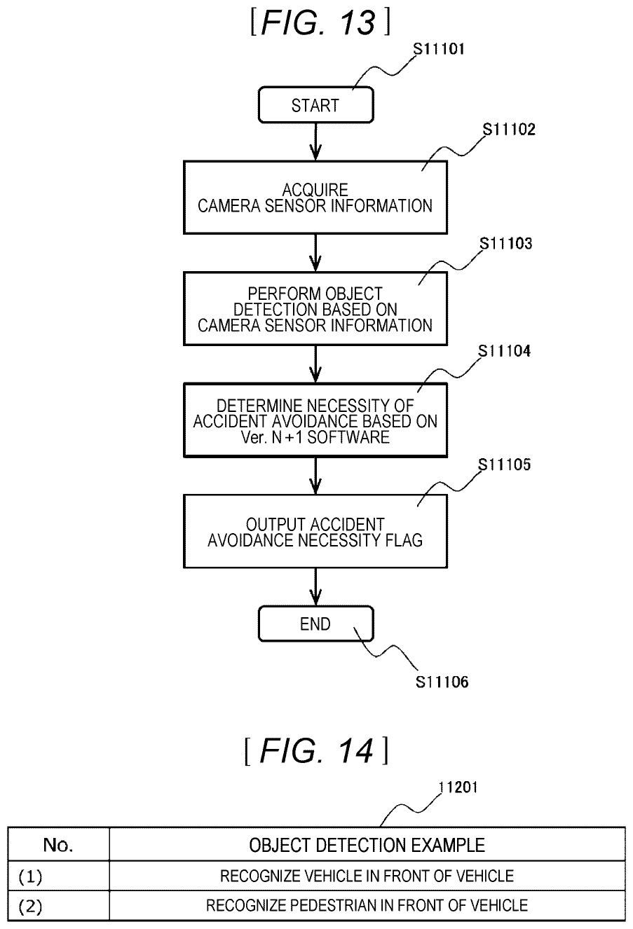

FIG. 13 is a flowchart illustrating an example of a processing procedure of the object detection unit (Ver. N+1) 111 according to the first example of the present invention. The accident avoidance determination is performed from the acquired camera sensor information. For example, the object detection unit (Ver. N+1) 111 (processor) acquires the camera sensor information 104 output by the camera sensor information acquisition unit 103 in step S11102 in the drawing, performs the object detection based on the camera sensor information in step S11103, determines the necessity of accident avoidance based on the object detection result in step S11104, and outputs the accident avoidance necessity flag in step S11105.

FIG. 14 is a diagram illustrating an example of the object detection result (Ver. N+1) 11201 according to the first example of the present invention. For example, there are a case where a vehicle in front of the vehicle is recognized (No. (1)) and a case where a pedestrian in front of the vehicle is recognized (No. (2)). Note that the present invention does not limit the detection target.

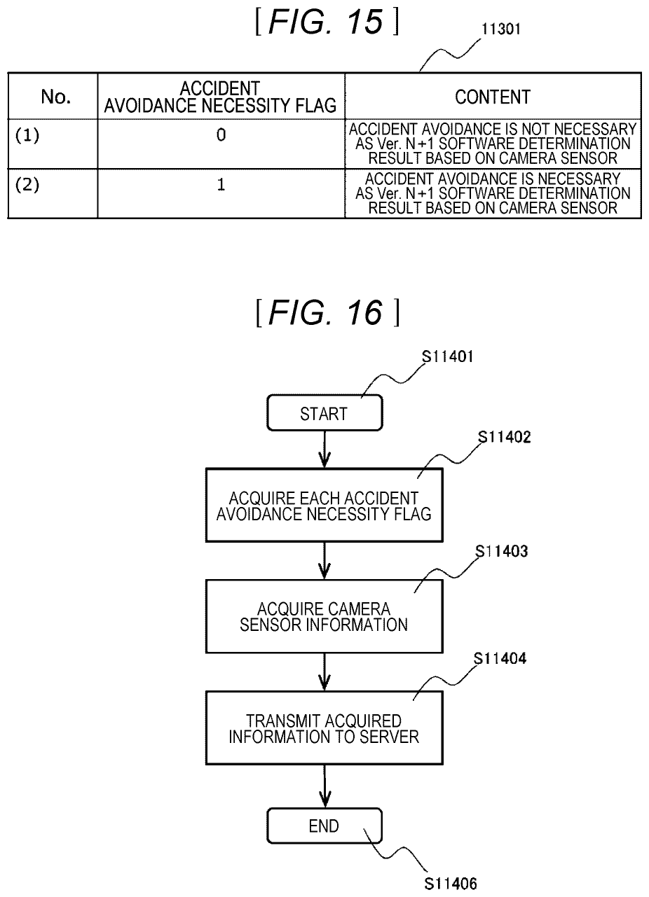

FIG. 15 is a diagram illustrating an example of an accident avoidance necessity flag (Ver. N+1) 11301 according to the first example of the present invention. An accident occurrence prediction of the vehicle is performed based on the object detection result (Ver. N+1) 11201, and an accident avoidance necessity flag is determined. For example, there are a flag 0 (No. (1)) in a case where an obstacle (a pedestrian etc.) is not recognized in front of the vehicle at the time of traveling of the vehicle and accident avoidance is not necessary, and a flag 1 (No. (2)) in a case where an obstacle is recognized in front of the vehicle at the time of traveling of the vehicle and accident avoidance is necessary. Note that the present invention also includes a case where an obstacle is recognized in front of the vehicle but accident avoidance is not necessary. Note that the accident avoidance necessity flag includes time stamp information.

FIG. 16 is a flowchart illustrating an example of a processing procedure of the server transmission unit 114 according to the first example of the present invention. The server transmission unit 114 (the processor and the communication device) acquires each accident avoidance necessity flag in step S11402, and acquires the synchronized camera sensor information in step S11403. In step S11404, the acquired information is transmitted to the server.

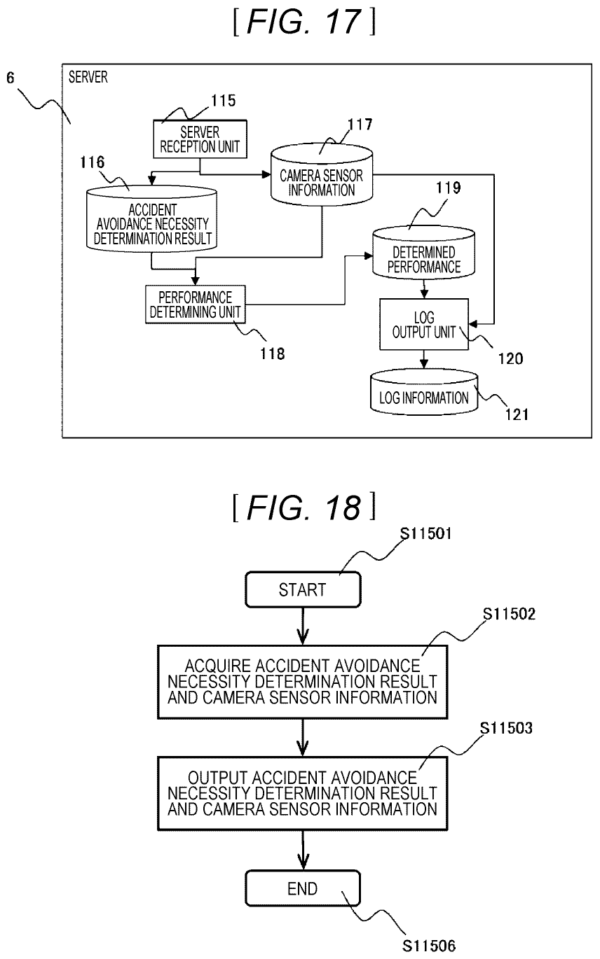

FIG. 17 is a diagram illustrating an overall configuration of a server system according to the first example of the present invention.

The server 6 includes a server reception unit 115, an accident avoidance necessity determination result 116, camera sensor information 117, a performance determining unit 118, a determined performance 119, a log output unit 120, and log information 121.

Note that the server 6 includes, for example, a processor such as a CPU, a storage device such as a memory and a hard disk, a communication device complying with various communication standards, and the like. The functions of the performance determining unit 118 and the like are implemented, for example, by the processor executing software stored in the storage device. Hereinafter, the same applies to other functions.

FIG. 18 is a flowchart illustrating an example of a processing procedure in the server reception unit 115 according to the first example of the present invention. For example, the server reception unit 115 (the processor and the communication device) acquires the accident avoidance necessity result (accident avoidance necessity flag (radar)) 107, the accident avoidance necessity flag (Ver. N) 110, the accident avoidance necessity flag (Ver. N+1) 113.) and the camera sensor information 104 in step S11502, and outputs the accident avoidance necessity result (accident avoidance necessity flag (radar)) 107, the accident avoidance necessity flag (Ver. N) 110, and the accident avoidance necessity flag (Ver. N+1) 113. ) and the camera sensor information 104 in step S11503.

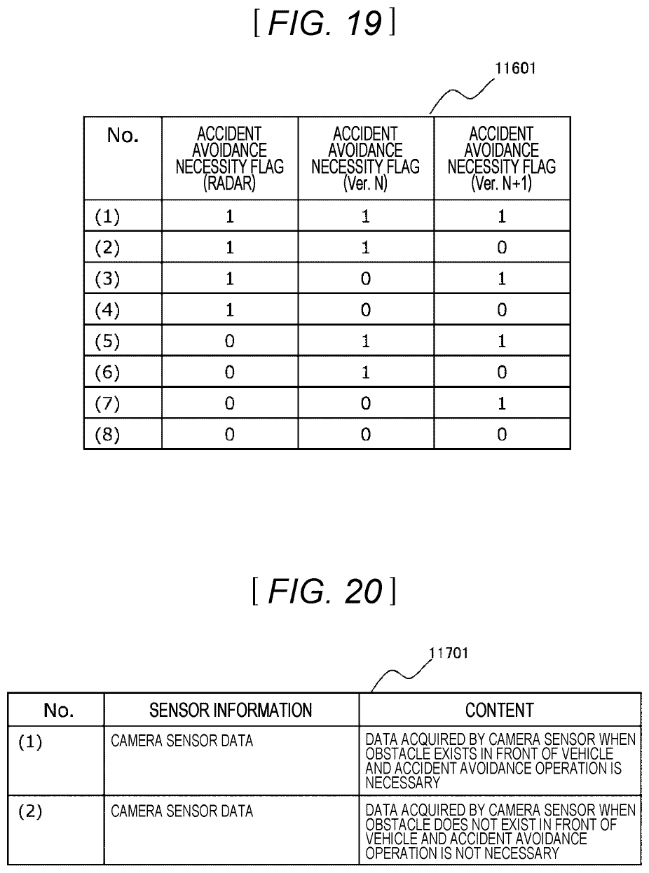

FIG. 19 is a diagram illustrating an example of an accident avoidance necessity determination result 11601 according to the first example of the present invention. For example, there are a case where the accident avoidance necessity flag (radar) 107 needs to be avoided, the accident avoidance necessity flag (Ver. N) 110 needs to be avoided, and the accident avoidance necessity flag (Ver. N+1) 113 needs to be avoided (No. (1)), a case where the accident avoidance necessity flag (radar) 107 needs to be avoided, the accident avoidance necessity flag (Ver. N) 110 needs to be avoided, and the accident avoidance necessity flag (Ver. N+1) 113 does not need to be avoided (No. (2)), a case where the accident avoidance necessity flag (radar)) 107 needs to be avoided, the accident avoidance necessity flag (Ver. N) 110 does not need to be avoided, and the accident avoidance necessity flag (Ver. N+1) 113 needs to be avoided (No. (3)), a case where the accident avoidance necessity flag (radar)) 107 needs to be avoided, the accident avoidance necessity flag (Ver. N) 110 does not need to be avoided, and the accident avoidance necessity flag (Ver. N+1) 113 does not need to be avoided (No. (4)), a case where the accident avoidance necessity flag (radar)) 107 does not need to be avoided, the accident avoidance necessity flag (Ver. N) 110 needs to be avoided, and the accident avoidance necessity flag (Ver. N+1) 113 needs to be avoided (No. (5)), a case where the accident avoidance necessity flag (radar)) 107 does not need to be avoided, the accident avoidance necessity flag (Ver. N) 110 needs to be avoided, and the accident avoidance necessity flag (Ver. N+1) 113 does not need to be avoided (No. (6)), a case where the accident avoidance necessity flag (radar) 107 does not need to be avoided, the accident avoidance necessity flag (Ver. N) 110 does not need to be avoided, and the accident avoidance necessity flag (Ver. N+1) 113 needs to be avoided (No. (7)), and a case where the accident avoidance necessity flag (radar) 107 does not need to be avoided, the accident avoidance necessity flag (Ver. N) 110 does not need to be avoided, and the accident avoidance necessity flag (Ver. N+1) 113 does not need to be avoided (No. (8)).

FIG. 20 is a diagram illustrating an example of camera sensor information 11701 according to the first example of the present invention. Sensor information by the camera includes sensor data (No. (1)) in a case where an obstacle such as a pedestrian exists in front of the vehicle and the accident avoidance operation is necessary, and sensor data (No. (2)) in a case where an obstacle such as a pedestrian does not exist in front of the vehicle and the accident avoidance operation is not necessary. Note that the sensor information includes time stamp information.

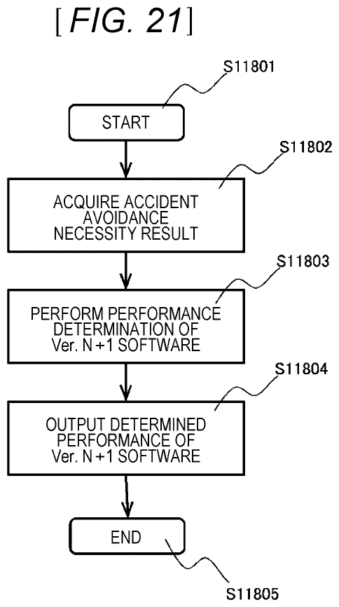

FIG. 21 is a flowchart illustrating an example of a processing procedure of the performance determining unit 118 according to the first example of the present invention. The performance of the Ver. N+1 software is determined based on the accident avoidance necessity result. For example, the performance determining unit 118 (processor) acquires the accident avoidance necessity determination result 116 in step S11802, performs the performance determination of the Ver. N+1 software in step S11803, and outputs the determined performance of the Ver. N+1 software in step S11804. Note that the present invention enables use of other information for performance determination.

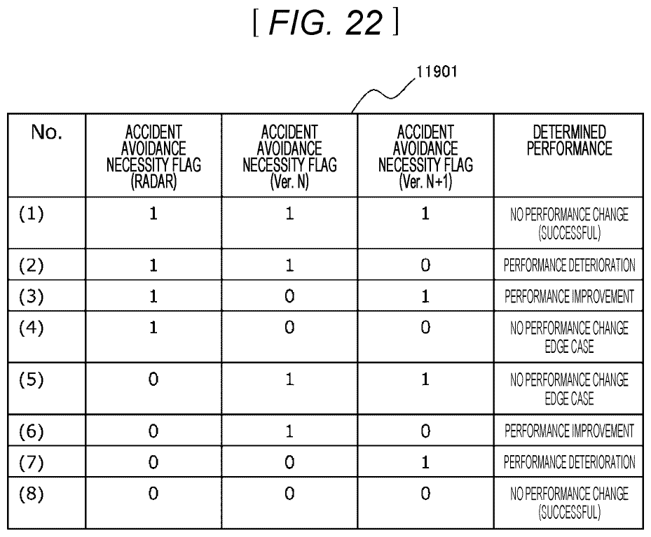

FIG. 22 is a diagram illustrating an example of the determined performance 11901 according to the first example of the present invention. The performance of Ver. N+1 is represented by a combination of information of each accident avoidance necessity flag.

For example, the determination result for a case where the accident avoidance necessity flag (radar) 107 needs to be avoided, the accident avoidance necessity flag (Ver. N) 110 needs to be avoided, and the accident avoidance necessity flag (Ver. N+1) 113 needs to be avoided (No. (1)) is no performance change (successful).

The determination result for a case where the accident avoidance necessity flag (radar) 107 needs to be avoided, the accident avoidance necessity flag (Ver. N) 110 needs to be avoided, and the accident avoidance necessity flag (Ver. N+1) 113 does not need to be avoided (No. (2)) is performance deterioration.

The determination result for a case where the accident avoidance necessity flag (radar) 107 needs to be avoided, the accident avoidance necessity flag (Ver. N) 110 does not need to be avoided, and the accident avoidance necessity flag (Ver. N+1) 113 needs to be avoided (No. (3)) is performance improvement.

The determination result for a case where the accident avoidance necessity flag (radar) 107 needs to be avoided, the accident avoidance necessity flag (Ver. N) 110 does not need to be avoided, and the accident avoidance necessity flag (Ver. N+1) 113 does not need to be avoided (No. (4)) is no performance change (edge case).

The determination result for a case where the accident avoidance necessity flag (radar) 107 does not need to be avoided, the accident avoidance necessity flag (Ver. N) 110 needs to be avoided, and the accident avoidance necessity flag (Ver. N+1) 113 needs to be avoided (No. (5)) is no performance change (edge case).

The determination result for a case where the accident avoidance necessity flag (radar) 107 does not need to be avoided, the accident avoidance necessity flag (Ver. N) 110 needs to be avoided, and the accident avoidance necessity flag (Ver. N+1) 113 does not need to be avoided (No. (6)) is performance improvement.

The determination result for a case where the accident avoidance necessity flag (radar) 107 does not need to be avoided, the accident avoidance necessity flag (Ver. N) 110 does not need to be avoided, and the accident avoidance necessity flag (Ver. N+1) 113 needs to be avoided (No. (7)) is performance deterioration.

The determination result for a case where the accident avoidance necessity flag (radar) 107 does not need to be avoided, the accident avoidance necessity flag (Ver. N) 110 does not need to be avoided, and the accident avoidance necessity flag (Ver. N+1) 113 does not need to be avoided (No. (8)) is no performance change (successful).

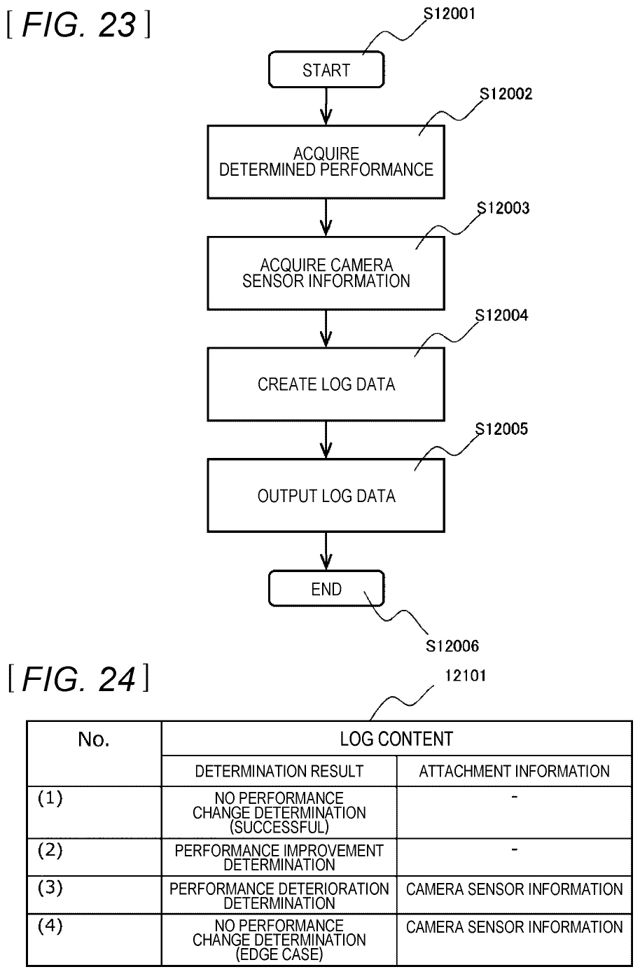

FIG. 23 is a flowchart illustrating an example of a processing procedure of the log output unit 120 according to the first example of the present invention. For example, the log output unit 120 (processor) acquires the determined performance 119 in step S12002, acquires the camera sensor information 117 synchronized with the determined performance in step S12003, creates log information by a combination of the determined performance 119 and the camera sensor information 117 when the determined performance 119 indicates performance deterioration or no performance change (edge case) in step S12004, and outputs the log information in step S12005. Note that, even in a case where the determined performance 119 is other information, log information combined with the camera sensor information 117 can be created.

FIG. 24 is a diagram illustrating an example of log information 12101 according to the first example of the present invention. The log information includes determined performance information and camera sensor information of Ver. N+1 software. For example, the log information is only the no performance change (successful) information when the determined performance 119 indicates no performance change (successful) (No. (1)), is only the performance improvement determination information when the determined performance 119 indicates performance improvement (No. (2)), is the performance improvement determination information and the camera sensor information when the determined performance 119 indicates performance deterioration (No. (3)), and is the no performance change (edge case) determination information and the camera sensor information when the determined performance 119 indicates no performance change (edge case) (No. (4)). Note that, in the present invention, the information to be included in the log information is not limited to the camera sensor information, and can include other information such as radar sensor information.

The main features of the first example can also be summarized as follows.

The vehicle control device 1 and the server 6 constitute a software verification system that verifies a new version (Ver. N+1) of control software (software for realizing object detection unit (Ver. N+1) 111).

The software verification system (server 6) detects the degradation (performance deterioration) of the new version (Ver. N+1) of control software by using the first information (accident avoidance necessity flag (Ver. N) 110), the second information (accident avoidance necessity flag (Ver. N+1) 113), and the third information (accident avoidance necessity flag (radar) 107) relating to the control of the vehicle other than the first and the second information.

Here, the first information (accident avoidance necessity flag (Ver. N) 110) is an output of a current version (Ver. N) of control software (software for realizing object detection unit (Ver. N) 108) used for controlling the vehicle, with sensor data (camera sensor information 104) from a sensor (camera sensor information acquisition unit 103) mounted on the vehicle as an input. Furthermore, the second information (accident avoidance necessity flag (Ver. N+1) 113) is an output of a new version (Ver. N+1) of control software (software for realizing object detection unit (Ver. N+1) 111) not used for controlling the vehicle, with sensor data (camera sensor information 104) as an input.

The software verification system (server 6) verifies (re-verifies) the new version of control software using the sensor data (camera sensor information 104) when the degradation is detected.

The detection performance of the degradation can be improved by using the third information (accident avoidance necessity flag (radar) 107). In addition, the control software can be rapidly verified by using the sensor data (camera sensor information 104) when the degradation is detected. As a result, improvement of software having sensor data of the vehicle as an input can be facilitated.

When the first information (accident avoidance necessity flag (Ver. N) 110) and the second information (accident avoidance necessity flag (Ver. N+1) 113) do not match and the first information (accident avoidance necessity flag (Ver. N) 110) and the third information (accident avoidance necessity flag (radar) 107) match, the software verification system (server 6) determines degradation (performance deterioration).

The degradation of the control software can be reliably detected by comparing the first information with the second information and comparing the first information with the third information.

In the present example, the third information (accident avoidance necessity flag (radar) 107) is information indicating the necessity of accident avoidance based on the radar sensor. A sensor (which outputs sensor data to be input to the control software) mounted on the vehicle is a camera (camera sensor information acquisition unit 103).

The detection performance of degradation of control software having sensor data of a camera as an input can be improved by using the necessity of accident avoidance based on a radar sensor with high reliability.

Specifically, the software verification system determines a change in performance of the new version of software with respect to the current version of software by using the first information, the second information, and the third information, and verifies the new version of software by using sensor data corresponding to a time when the change in performance is determined.

The change in performance of the new version of software can be finely determined by using the first information, the second information, and the third information. As a result, improvement of software having sensor data of the vehicle as an input can be facilitated.

Specifically, the software verification system determines that there is no change in performance when the first information, the second information and the third information are information indicating that the accident avoidance is necessary or that the accident avoidance has been carried out (No. (1) of FIG. 22), determines that the performance has deteriorated when the first information and the third information are information indicating that the accident avoidance is necessary or that the accident avoidance has been carried out, and the second information is information indicating that the accident avoidance is not necessary or that the accident avoidance has not been carried out (No. (2) of FIG. 22), determines that the performance has improved when the second information and the third information are information indicating that the accident avoidance is necessary or that the accident avoidance has been carried out, and the first information is information indicating that the accident avoidance is not necessary or that the accident avoidance has not been carried out (No. (3) of FIG. 22), determines that there is no change in performance when the third information is information indicating that the accident avoidance is necessary or that the accident avoidance has been carried out, and the first information and the second information are information indicating that the accident avoidance is not necessary or that the accident avoidance has not been carried out (No. (4) of FIG. 22), determines that there is no change in performance when the first information and the second information are information indicating that the accident avoidance is necessary or that the accident avoidance has been carried out, and the third information is information indicating that the accident avoidance is not necessary or that the accident avoidance has not been carried out (No. (5) of FIG. 22), determines that the performance has improved when the first information is information indicating that the accident avoidance is necessary or that the accident avoidance has been carried out, and the second information and the third information are information indicating that the accident avoidance is not necessary or that the accident avoidance has not been carried out (No. (6) of FIG. 22), determines that the performance has deteriorated when the second information is information indicating that the accident avoidance is necessary or that the accident avoidance has been carried out, and the first information and the third information are information indicating that the accident avoidance is not necessary or that the accident avoidance has not been carried out (No. (7) of FIG. 22), and determines that there is no change in performance when the first information, the second information, and the third information are information indicating that the accident avoidance is not necessary or that the accident avoidance has not been carried out (No. (8) of FIG. 22).

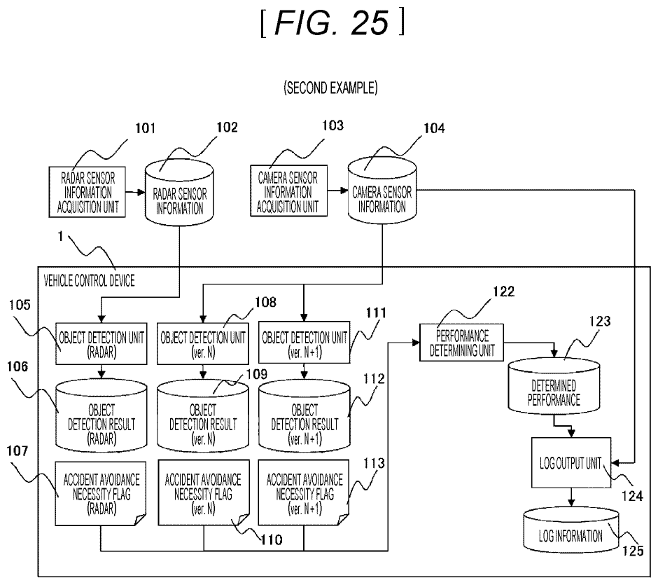

Here, the first information and the second information are information indicating the necessity or presence or absence of accident avoidance based on sensor data, and the third information is information indicating the necessity or presence or absence of accident avoidance based on data different from the sensor data. In the present example, the change in performance is determined by the server 6 (the performance determining unit 118 in FIG. 17), but may be determined by the vehicle control device 1 (a performance determining unit 122 in FIG. 25 described later).

Since there are two ways for each of the first information, the second information, and the third information, it is possible to determine changes in performance of the new version of software for eight ways.

The software verification system performs machine learning using sensor data corresponding to the determination results of Nos. (2), (4), (5), and (7) in FIG. 22 as train data for a case where improvement of the new version of software is necessary, or performs machine learning using sensor data corresponding to the determination results of Nos. (1), (3), (6), and (8) in FIG. 22 as train data for a case where improvement of the new version of software is not necessary.

Since the train data of the case where improvement is necessary or the train data of the case where improvement is not necessary is acquired from the real environment, the learning accuracy and the learning speed are improved.

As described above, the software verification system according to the present example is configured to compare the output of the current version of control software, the output of the new version of control software, and other pieces of information relating to vehicle control, so that degradation of the new version of software can be detected. As a result, there is an effect of enabling data collection and re-verification effective for improving the new version of software.

### Second Example

### Consider the Case of Storing Data

A vehicle control device and a method according to a second example of the present invention will be described with reference to FIGS. 25 through 29.

The difference from the first example is that, instead of transmitting all of the accident avoidance necessity flag (radar) 107, the accident avoidance necessity flag (Ver. N) 110, the accident avoidance necessity flag (Ver. N+1) 113, and the camera sensor information 104 to the server, the performance determination of the Ver. N+1 software is performed in the vehicle control device 1 based on these pieces of information. In the second example, there is an effect of reducing the amount of data of the log information described in the first example and reducing the communication amount. Note that configurations and procedures similar to those in the first example are denoted by the same reference numerals, and the description thereof is omitted.

FIG. 25 is a diagram illustrating an overall configuration of a vehicle control device 1 according to the second example of the present invention. In the second example as well, the vehicle control device includes, instead of the server transmission unit 114, a performance determining unit 122, a determined performance 123, a log output unit 124, and log information 125.

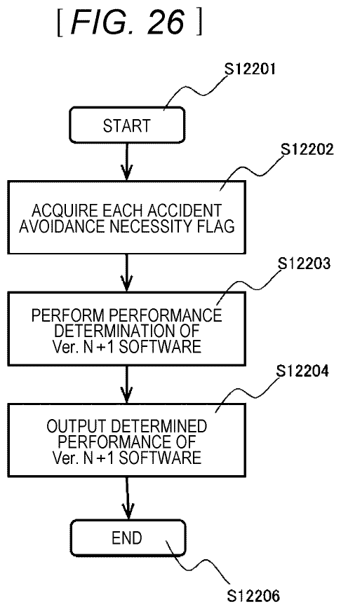

FIG. 26 is a flowchart illustrating an example of a processing procedure of the performance determining unit 122 according to the second example of the present invention. The performance of the Ver. N+1 software is determined based on the accident avoidance necessity flag. For example, the performance determining unit 122 (processor) acquires the accident avoidance necessity flag (radar) 107, the accident avoidance necessity flag (Ver. N) 110, and the accident avoidance necessity flag (Ver. N+1) 113 in step S12202, performs the performance determination of the Ver. N+1 software in step S12203, and outputs the determined performance of the Ver. N+1 software in step S12204. Note that the present invention enables use of other information for performance determination.

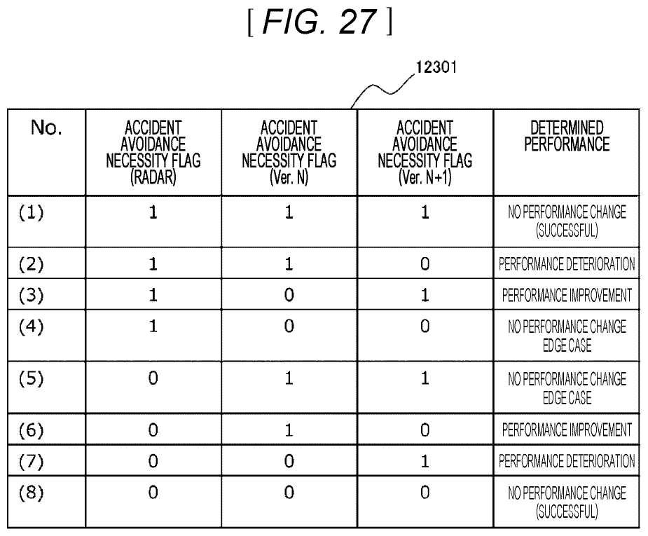

FIG. 27 is a diagram illustrating an example of the determined performance 12301 according to the second example of the present invention. The performance of Ver. N+1 is represented by a combination of information of each accident avoidance necessity flag.

For example, the determination result for a case where the accident avoidance necessity flag (radar) 107 needs to be avoided, the accident avoidance necessity flag (Ver. N) 110 needs to be avoided, and the accident avoidance necessity flag (Ver. N+1) 113 needs to be avoided (No. (1)) is no performance change (successful).

The determination result for a case where the accident avoidance necessity flag (radar) 107 needs to be avoided, the accident avoidance necessity flag (Ver. N) 110 needs to be avoided, and the accident avoidance necessity flag (Ver. N+1) 113 does not need to be avoided (No. (2)) is performance deterioration.

The determination result for a case where the accident avoidance necessity flag (radar) 107 needs to be avoided, the accident avoidance necessity flag (Ver. N) 110 does not need to be avoided, and the accident avoidance necessity flag (Ver. N+1) 113 needs to be avoided (No. (3)) is performance improvement.

The determination result for a case where the accident avoidance necessity flag (radar) 107 needs to be avoided, the accident avoidance necessity flag (Ver. N) 110 does not need to be avoided, and the accident avoidance necessity flag (Ver. N+1) 113 does not need to be avoided (No. (4)) is no performance change (edge case).

The determination result for a case where the accident avoidance necessity flag (radar) 107 does not need to be avoided, the accident avoidance necessity flag (Ver. N) 110 needs to be avoided, and the accident avoidance necessity flag (Ver. N+1) 113 needs to be avoided (No. (5)) is no performance change (edge case).

The determination result for a case where the accident avoidance necessity flag (radar) 107 does not need to be avoided, the accident avoidance necessity flag (Ver. N) 110 needs to be avoided, and the accident avoidance necessity flag (Ver. N+1) 113 does not need to be avoided (No. (6)) is performance improvement.

The determination result for a case where the accident avoidance necessity flag (radar) 107 does not need to be avoided, the accident avoidance necessity flag (Ver. N) 110 does not need to be avoided, and the accident avoidance necessity flag (Ver. N+1) 113 needs to be avoided (No. (7)) is performance deterioration.

The determination result for a case where the accident avoidance necessity flag (radar) 107 does not need to be avoided, the accident avoidance necessity flag (Ver. N) 110 does not need to be avoided, and the accident avoidance necessity flag (Ver. N+1) 113 does not need to be avoided (No. (8)) is no performance change (successful).

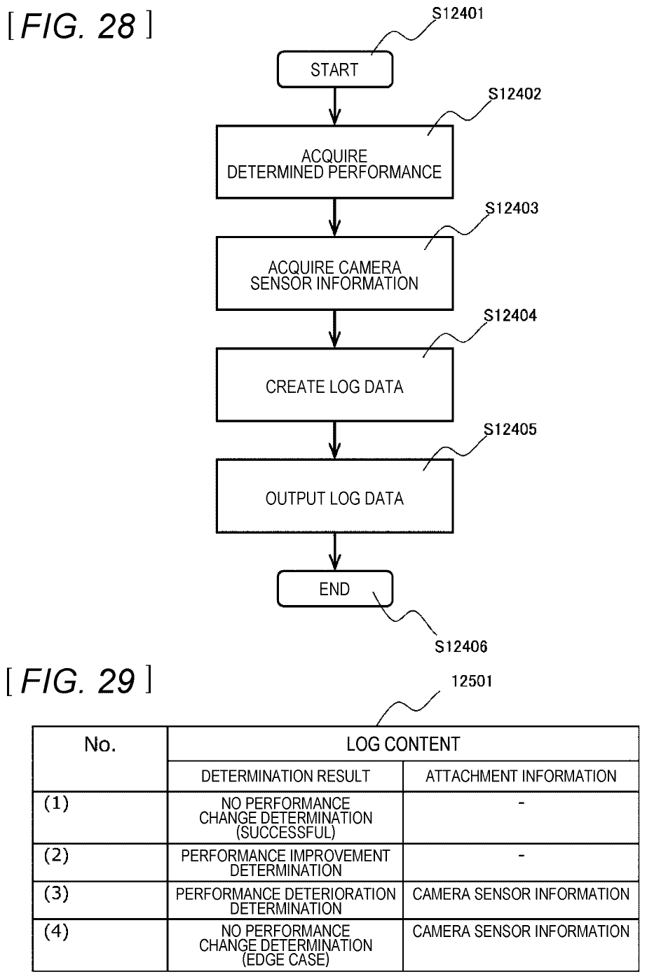

FIG. 28 is a flowchart illustrating an example of a processing procedure of the log output unit 124 according to the second example of the present invention. For example, the log output unit 124 (processor) acquires the determined performance 123 in step S12402, acquires the camera sensor information 104 synchronized with the determined performance in step S12403, creates log information by a combination of the determined performance 123 and the camera sensor information 104 when the determined performance 123 indicates performance deterioration or no performance change (edge case) in step S12404, and outputs the log information in step S12405. Note that, even in a case where the determined performance 123 is other information, log information combined with the camera sensor information 104 can be created.

FIG. 29 is a diagram illustrating an example of log information 12501 according to the second example of the present invention. The log information includes determined performance information and camera sensor information of Ver. N+1 software. For example, the log information is only the no performance change (successful) information when the determined performance 123 indicates no performance change (successful) (No. (1)), is only the performance improvement determination information when the determined performance 123 indicates performance improvement (No. (2)), is the performance improvement determination information and the camera sensor information when the determined performance 123 indicates performance deterioration (No. (3)), and is the no performance change (edge case) determination information and the camera sensor information when the determined performance 123 indicates no performance change (edge case) (No. (4)). Note that, in the present invention, the information to be included in the log information is not limited to the camera sensor information, and can include other information such as radar sensor information.

The main features of the second example can also be summarized as follows.

The vehicle control device 1 includes a degradation detection unit (performance determining unit 122) configured to detect a degradation (performance deterioration) of a new version (Ver. N+1) of control software using first information (accident avoidance necessity flag (Ver. N) 110), second information (accident avoidance necessity flag (Ver. N+1) 113), and third information (accident avoidance necessity flag (radar) 107) relating to control of the vehicle other than the first and the second information, and a log information adding unit (log output unit 124) configured to add log information relating to the degradation to sensor data (camera sensor information 104) at a time when the degradation is detected by the degradation detection unit.

Here, the first information (accident avoidance necessity flag (Ver. N) 110) is an output of a current version (Ver. N) of control software used for controlling the vehicle with sensor data (camera sensor information 104) from a sensor (camera sensor information acquisition unit 103) mounted on the vehicle as an input. Furthermore, the second information (accident avoidance necessity flag (Ver. N+1) 113) is an output of a new version (Ver. N+1) of control software that uses sensor data (camera sensor information 104) as input and that is not used for control of the vehicle.

The verification of the degradation using the sensor data is facilitated by adding the log information relating to degradation to the sensor data (camera sensor information 104). As a result, improvement of software having sensor data of the vehicle as an input can be facilitated. Note that, when a charging cable of a charger of the charging station is connected to a charging socket of a vehicle (electric vehicle etc.), the sensor data (camera sensor information 104) to which the log information is added may be uploaded to the server.

As described above, the vehicle control device according to the present example is configured to perform the performance determination of Ver. N+1 and create the log information together with the camera sensor information inside the vehicle control device 1, thereby enabling pick and choose of the camera sensor information. As a result, for example, there is an effect that the amount of communication data is reduced at the time of uploading the log information.

### Third Example

### Real-Time Transmission

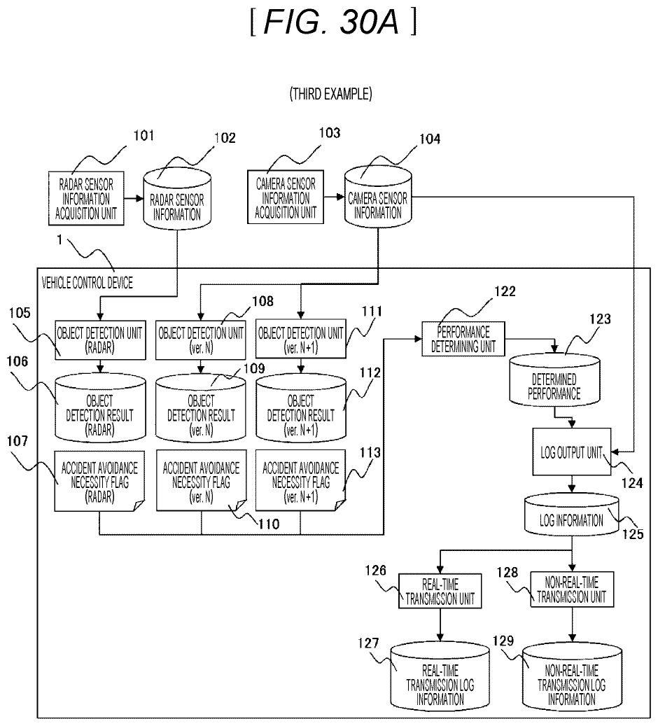

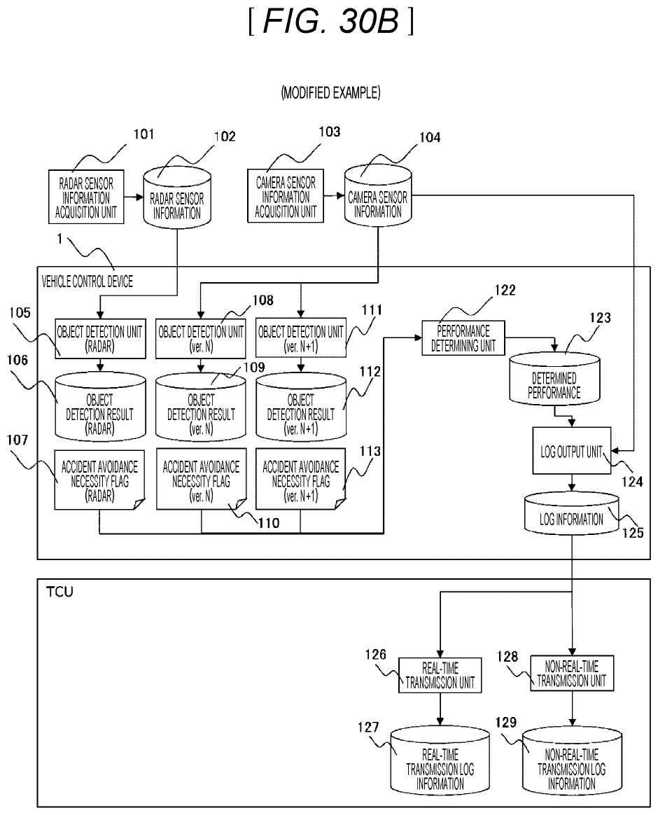

A vehicle control device and a method according to a third example of the present invention will be described with reference to FIGS. 30A through 34.

The difference from the first example is that, instead of transmitting all of the accident avoidance necessity flag (radar) 107, the accident avoidance necessity flag (Ver. N) 110, the accident avoidance necessity flag (Ver. N+1) 113, and the camera sensor information 104 to the server, the performance determination of the Ver. N+1 software is performed in the vehicle control device 1 based on these pieces of information, and the log information is classified according to the determination result and transmitted in real time or non-real-time. The third example has an effect of enabling verification in the server to be rapidly performed while suppressing an increase in processing load in the vehicle due to data transmission to the server. Note that configurations and procedures similar to those in the first example are denoted by the same reference numerals, and the description thereof is omitted.

FIG. 30A is a diagram illustrating an overall configuration of a vehicle control device 1 according to the third example of the present invention. As compared with the first example, the vehicle control device 1 according to the third example includes, instead of the server transmission unit 114, a performance determining unit 122, a determined performance 123, a log output unit 124, log information 125, a real-time transmission unit 126, real-time transmission log information 127, a non-real-time transmission unit 128, and non-real-time transmission log information 129. Note that as illustrated in FIG. 30B, the real-time transmission unit 126, the real-time transmission log information 127, the non-real-time transmission unit 128, and the non-real-time transmission log information 129 may be provided in another electronic control device such as a telematics control unit (TCU).

FIG. 31 is a flowchart illustrating an example of a processing procedure of the real-time transmission unit 126 according to the third example of the present invention. The real-time transmission unit 126 (processor and communication device) acquires the log information 125 in step S12602, extracts the log data in the case where the Ver. N+1 software indicates performance deterioration or no performance change (edge case) in step S12603, and transmits the extracted log data in real time in step S12604. Note that in the present invention, the log information to be transmitted in real-time can be changed.

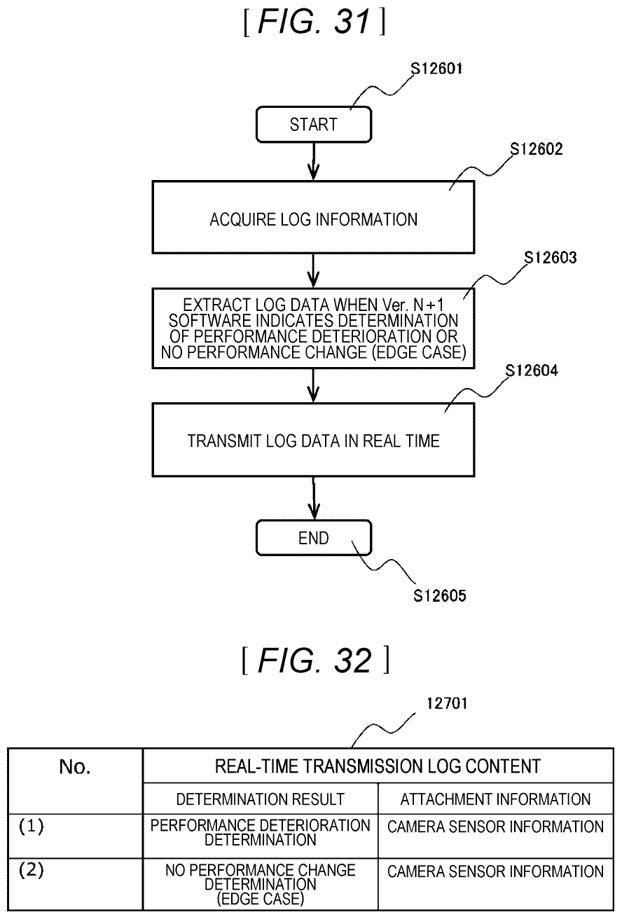

FIG. 32 is a diagram illustrating an example of real-time transmission log information 12701 according to the third example of the present invention. For example, the transmission real-time transmission log information includes determination information when the Ver. N+1 software indicates performance deterioration and camera sensor information (No. (1)), and determination information when the Ver. N+1 software indicates no performance change (edge case) and camera sensor information (No. (2)). Note that, in the present invention, the information to be included in the log information is not limited to the camera sensor information, and can include other information such as radar sensor information.

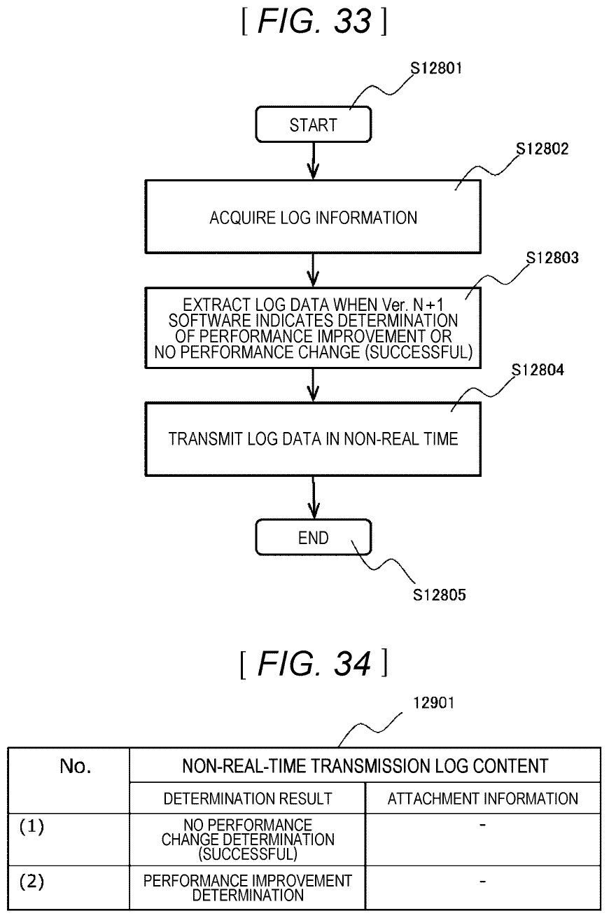

FIG. 33 is a flowchart illustrating an example of a processing procedure of the non-real-time transmission unit 128 according to the third example of the present invention. The non-real-time transmission unit 128 (processor and communication device) acquires the log information 125 in step S12802, extracts the log data in a case where the Ver. N+1 software indicates performance improvement or no performance change (successful) in step S12803, and transmits the extracted log data in non-real time in step S12804. For example, by temporarily saving the log data in the in-vehicle storage, data is collectively transmitted while the vehicle is stopped, and an increase in processing load in the vehicle due to the data transmission to the server is suppressed. Note that in the present invention, the log information to be transmitted in non-real-time can be changed. In addition, non-real-time transmission may be performed when the processing load of the vehicle control device 1 is smaller than a predetermined value.

FIG. 34 is a diagram illustrating an example of non-real-time transmission log information 12901 according to the third example of the present invention. For example, the non-real-time transmission log information includes determination information when the Ver. N+1 software indicates no performance change (successful) (No. (1)) and determination information when the Ver. N+1 software indicates performance improvement (No. (2)). Note that, in the present example, the non-real-time transmission log information does not include the camera sensor information, but may include the camera sensor information corresponding to the determination result (determined performance).

The main features of the third example can also be summarized as follows.

A software verification system (vehicle control device 1) includes a degradation detection unit (performance determining unit 122) mounted on a vehicle and configured to detect a degradation, a log information adding unit (log output unit 124) mounted on the vehicle and configured to add log information relating to the degradation to sensor data (camera sensor information 104) at a time when the degradation is detected by the degradation detection unit (performance determining unit 122), and a data transmission unit (real-time transmission unit 126, non-real-time transmission unit 128) mounted on the vehicle and configured to transmit the sensor data (camera sensor information 104) to which the log information is added to a server 6.

By transmitting the sensor data to which the log information is added to the server, verification can be performed using the sensor data for each piece of log information on the server side.

Note that, as illustrated in FIG. 30B, the vehicle control device 1 used in the software verification system may output sensor data (camera sensor information 104) to which log information is added to the data transmission unit (the real-time transmission unit 126 and the non-real-time transmission unit 128 provided in the TCU) configured to transmit the data to the server 6.

The manufacturing cost can be reduced by not providing the data transmission unit configured to transmit data to the server 6 in the vehicle control device 1.

The software verification system (vehicle control device 1) includes a storage unit (storage device) mounted on the vehicle and configured to save log information (real-time transmission log information 127, non-real-time transmission log information 129). In the present example, the data transmission unit (non-real-time transmission unit 128) transmits, to the server, data (non-real-time transmission log information 129) stored in the storage unit when the vehicle is stopped.

A processing load can be suppressed while securing hardware resources to be used for controlling the vehicle at the time of traveling by transmitting data (non-real-time transmission log information 129) to the server when the vehicle is stopped.

As described above, the vehicle control device according to the present example has a configuration in which the log information transmission process is divided in real time or non-real-time, so that the log information can be transmitted in consideration of the processing load in the vehicle control device. As a result, the hardware cost can be reduced.

### Fourth Example

Specific Example of Accident Avoidance Flag Using information of Driver

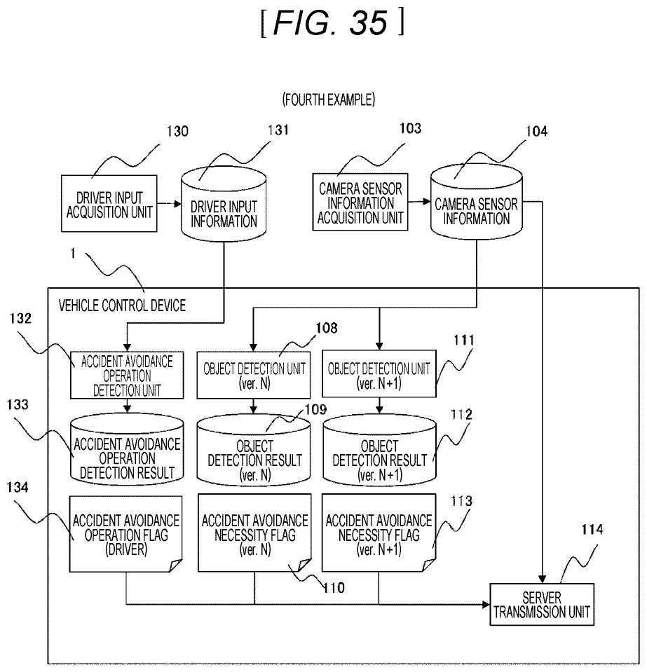

A vehicle control device and a method according to a fourth example of the present invention will be described with reference to FIGS. 35 through 40.

The difference from the first example is that, instead of the radar sensor information acquisition unit 101 and the radar sensor information 102, the accident avoidance operation flag is prepared using a driver input acquisition unit 130 and driver input information 131. In the fourth example, there is an effect that accident occurrence cases that are difficult to recognize and determine by the in-vehicle sensor can be collected by recognition and determination of the driver, which can then be used for evaluation and improvement of Ver. N+1 software. Note that configurations and procedures similar to those in the first example are denoted by the same reference numerals, and the description thereof is omitted.

FIG. 35 is a diagram illustrating an overall configuration of a vehicle control device 1 according to the fourth example of the present invention. As compared with the first example, the vehicle control device 1 according to the fourth example includes a driver input acquisition unit 130 and driver input information 131 instead of the radar sensor information acquisition unit 101 and the radar sensor information 102, and an accident avoidance operation detection unit 132, an accident avoidance operation detection result 133, and an accident avoidance operation flag (driver) 134 instead of the object detection unit (radar) 105, the object detection result (radar) 106, and the accident avoidance necessity flag (radar) 107.

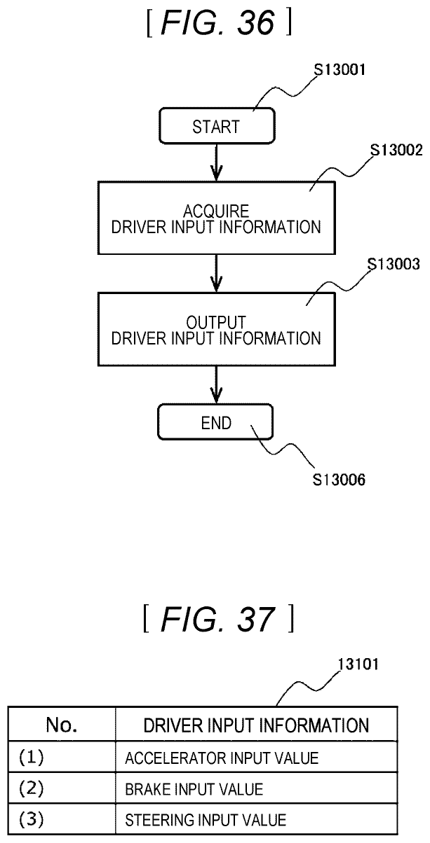

FIG. 36 is a flowchart illustrating an example of a processing procedure of the driver input acquisition unit 130 according to the fourth example of the present invention. The driver input acquisition unit 130 (accelerator opening sensor, brake depression amount sensor, steering angle sensor, etc.) acquires driver input information in step S13002, and outputs the driver input information in step S13003.

FIG. 37 is a diagram illustrating an example of driver input information 13101 according to the fourth example of the present invention. For example, there are an accelerator input value (No. (1)), a brake input value (No. (2)), and a steering input value (No. (3)).

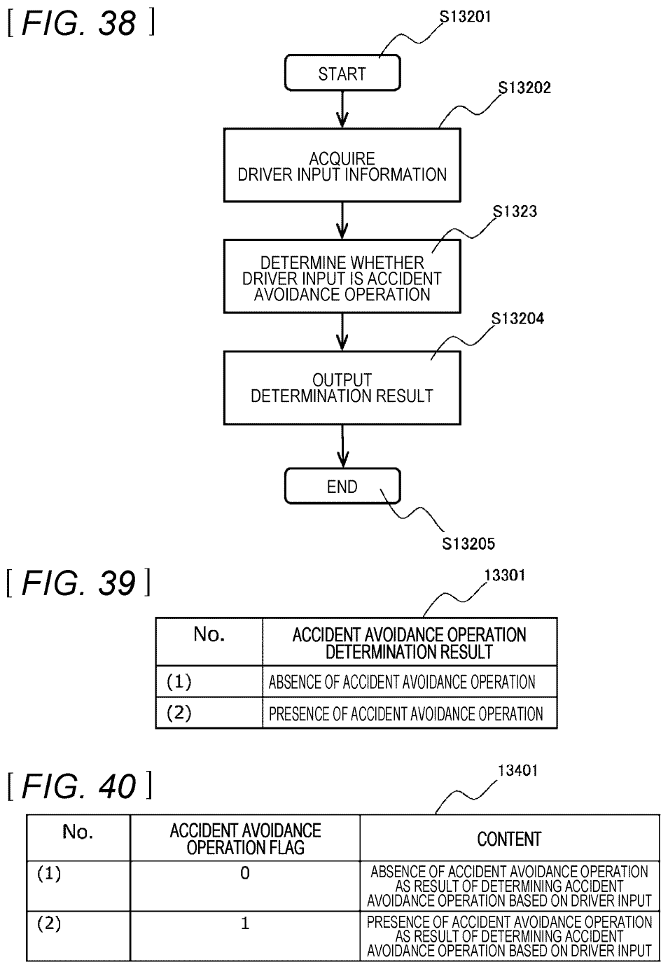

FIG. 38 is a flowchart illustrating a processing procedure of the accident avoidance operation detection unit 132 according to the fourth example of the present invention. The accident avoidance operation detection unit 132 (processor) acquires driver input information in step S13202, determines whether the driver input is an accident avoidance operation in step S13203, and outputs a determination result in step S13204. For example, the accident avoidance operation detection unit 132 determines the presence or absence of the accident avoidance operation from the change amount (time differential value) of the accelerator input value, the change amount (time differential value) of the brake input value, and the change amount (time differential value) of the steering input value.

FIG. 39 is a diagram illustrating an example of an accident avoidance operation determination result 13301 according to the fourth example of the present invention. For example, there are absence of accident avoidance operation (No. (1)) and presence of accident avoidance operation (No. (2)) as determination results.

FIG. 40 is a diagram illustrating an example of an accident avoidance operation flag 13401 according to the fourth example of the present invention. For example, there are a flag 0 (No. (1)) in a case where the accident avoidance operation is absent as a result of determining the accident avoidance operation based on the driver input, and a flag 1 (No. (2)) in a case where the accident avoidance operation is present as a result of determining the accident avoidance operation based on the driver input.

The main features of the fourth example can also be summarized as follows.

The software verification system (server 6) detects the degradation (performance deterioration) of the new version (Ver. N+1) of control software by using the first information (accident avoidance necessity flag (Ver. N) 110), the second information (accident avoidance necessity flag (Ver. N+1) 113), and the third information (accident avoidance operation flag (driver) 134) relating to the control of the vehicle other than the first and the second information. Here, the third information (accident avoidance operation flag (driver) 134) is information indicating the presence or absence of the accident avoidance operation by the driver.

The degradation detection performance can be improved by using the third information (accident avoidance operation flag (driver) 134).

Since the configuration and operation of the server 6 are the same as those of the first example, the description thereof will be omitted. The performance determining unit 122, the determined performance 123, the log output unit 124, and the log information 125 may be provided in the vehicle control device 1 as in the second example.

As described above, the software verification system according to the present example is configured to acquire the accident avoidance operation flag based on the input information by the driver, so that the determination result of the driver can be compared with the output result of the control software. As a result, there is an effect that sensor data at the time of a situation in which the system does not operate correctly can be acquired.

According to the first to fourth examples of the present invention, it is possible to perform performance determination of a new version of software by comparing an execution result of an old version of software, an execution result of a new version of software, and detected accident avoidance operation information, and to collect data necessary for performance improvement. In addition, it is possible to reduce the data amount of the log information to be transmitted to the server by picking and choosing sensor data according to the determined performance of the new version of software. In addition, by dividing the processing into real-time transmission or non-real-time transmission at the time of server transmission of the log information, the hardware cost can be reduced by data transmission in consideration of the processing load in the vehicle control device. Furthermore, sensor data under a situation in which the system does not operate correctly can be acquired by using the driver input information as the accident avoidance operation information.

Note that the present invention is not limited to the embodiments described above, and includes various modified examples. For example, the examples described above have been described in detail for the sake of easy understanding of the present invention, and are not necessarily limited to those having all the described configurations. In addition, a part of the configuration of a certain example can be replaced with a configuration of another embodiment, and the configuration of a certain embodiment can be added with the configuration of another embodiment. Furthermore, for a part of the configuration of each example, other configurations can be added, deleted, and replaced.

In addition, some of all of the above-described configurations, functions, and the like may be realized by hardware, for example, by designing with an integrated circuit. In addition, each of the above-described configurations, functions, and the like may be realized by software by a processor interpreting and executing a program for realizing each function. Information such as a program, a table, and a file for realizing each function can be stored in a recording device such as a memory, a hard disk, and a solid state drive (SSD), or a recording medium such as an IC card, an SD card, and a DVD.

### Reference Signs List

1 vehicle control device
2 gateway
3 camera control device
4 radar control device
5 sonar control device
6 server
101 radar sensor information acquisition unit
102 radar sensor information
103 camera sensor information acquisition unit
104 camera sensor information
105 object detection unit (radar)
106 object detection result (radar)
107 accident avoidance necessity flag (radar)
108 object detection unit (Ver. N)
109 object detection result (Ver. N)
110 accident avoidance necessity flag (Ver. N)
111 object detection unit (Ver. N+1)
112 object detection result (Ver. N+1)
113 accident avoidance necessity flag (Ver. N+1)
114 server transmission unit
115 server reception unit
116 accident avoidance necessity determination result
117 camera sensor information
118 performance determining unit
119 determined performance
120 log output unit
121 log information
122 performance determining unit
123 determined performance
124 log output unit
125 log information
126 real-time transmission unit
127 real-time transmission log information
128 non-real-time transmission unit
129 non-real-time transmission log information
130 driver input acquisition unit
131 driver input information
132 accident avoidance operation detection unit
133 accident avoidance operation detection result
134 accident avoidance operation flag (driver)

1. A software verification system configured to:
detect a degradation of a new version of control software using,
first information that is an output of a current version of control software used for control of a vehicle using, as an input, sensor data from a sensor mounted on the vehicle,
second information that is an output of the new version of control software not used for the control of the vehicle using, as an input, the sensor data, and
third information relating to the control of the vehicle other than the first and second information; and
verify the new version of control software by using the sensor data when the degradation is detected.

2. The software verification system according to claim 1, comprising:
a degradation detection unit mounted on the vehicle and configured to detect the degradation;
a log information adding unit mounted on the vehicle and configured to add log information relating to the degradation to the sensor data at a time when the degradation is detected by the degradation detection unit; and
a data transmission unit mounted on the vehicle and configured to transmit the sensor data to which the log information is added to a server.

3. The software verification system according to claim 2, further comprising
a storage unit mounted on the vehicle and configured to store the log information, wherein
the data transmission unit transmits data stored in the storage unit to the server when the vehicle is stopped.

4. The software verification system according to claim 1,
wherein when the first information and the second information do not match and the first information and the third information match, determination is made as degradation.

5. The software verification system according to claim 4, wherein the third
information is information indicating presence or absence of an accident avoidance operation by a driver.

6. The software verification system according to claim 4, wherein
the third information is information indicating necessity of accident avoidance based on a radar sensor, and
the sensor mounted on the vehicle is a camera.

7. A vehicle control device used in the software verification system according to claim 1, the vehicle control device comprising:
a degradation detection unit configured to detect the degradation;
a log information adding unit configured to add log information relating to the degradation to sensor data at a time when the degradation is detected by the degradation detection unit; and
a data transmission unit configured to transmit the sensor data to which the log information is added to a server.

8. A vehicle control device used in the software verification system according to claim 1, the vehicle control device comprising:
a degradation detection unit configured to detect the degradation; and
a log information adding unit configured to add log information relating to the degradation to sensor data at a time when the degradation is detected by the degradation detection unit; wherein
the sensor data to which the log information is added is output to a data transmission unit configured to transmit data to a server.

9. A vehicle control device comprising:
a degradation detection unit configured to detect a degradation of a new version of control software by using,
first information that is an output of a current version of control software used for control of a vehicle using, as an input, sensor data from a sensor mounted on the vehicle,
second information that is an output of the new version of control software not used for the control of the vehicle using, as an input, the sensor data, and
third information relating to the control of the vehicle other than the first and second information; and
a log information adding unit configured to add log information relating to the degradation to sensor data at a time when the degradation is detected by the degradation detection unit.

10. A software verification system configured to:
determine a change in performance of a new version of software with respect to a current version of software using,
first information that is an output of the current version of software used for control of a vehicle using, as an input, sensor data from a sensor mounted on the vehicle,
second information that is an output of the new version of software not used for the control of the vehicle using, as an input, the sensor data, and
third information relating to the control of the vehicle other than the first and second information; and
verify the new version of software by using the sensor data corresponding to a time when the change in performance is determined.

11. The software verification system according to claim 10, wherein
the first information and the second information are information indicating necessity or presence or absence of accident avoidance based on the sensor data,
the third information is information indicating necessity or presence or absence of accident avoidance based on data different from the sensor data,
(1) determination is made that there is no change in performance when the first information, the second information and the third information are information indicating that the accident avoidance is necessary or that the accident avoidance has been carried out,
(2) determination is made that the performance has deteriorated when the first information and the third information are information indicating that the accident avoidance is necessary or that the accident avoidance has been carried out, and the second information is information indicating that the accident avoidance is not necessary or that the accident avoidance has not been carried out,
(3) determination is made that the performance has improved when the second information and the third information are information indicating that the accident avoidance is necessary or that the accident avoidance has been carried out, and the first information is information indicating that the accident avoidance is not necessary or that the accident avoidance has not been carried out,
(4) determination is made that there is no change in performance when the third information is information indicating that the accident avoidance is necessary or that the accident avoidance has been carried out, and the first information and the second information are information indicating that the accident avoidance is not necessary or that the accident avoidance has not been carried out,
(5) determination is made that there is no change in performance when the first information and the second information are information indicating that the accident avoidance is necessary or that the accident avoidance has been carried out, and the third information is information indicating that the accident avoidance is not necessary or that the accident avoidance has not been carried out,
(6) determination is made that the performance has improved when the first information is information indicating that the accident avoidance is necessary or that the accident avoidance has been carried out, and the second information and the third information are information indicating that the accident avoidance is not necessary or that the accident avoidance has not been carried out,
(7) determination is made that the performance has deteriorated when the second information is information indicating that the accident avoidance is necessary or that the accident avoidance has been carried out, and the first information and the third information are information indicating that the accident avoidance is not necessary or that the accident avoidance has not been carried out, and
(8) determination is made that there is no change in performance when the first information, the second information, and the third information are information indicating that the accident avoidance is not necessary or that the accident avoidance has not been carried out.

12. The software verification system according to claim 11, configured to:
perform machine learning using sensor data corresponding to the determination results of (2), (4), (5), and (7) as train data for a case where improvement of the new version of software is necessary, or
perform machine learning using sensor data corresponding to the determination results of (1), (3), (6), and (8) as train data for a case where improvement of the new version of software is not necessary.
